(19) United States
(12) Patent Application Publication
(10) Pub. No.: US 2026/0341237 A1
(43) Pub. Date: Oct. 29, 2026

(54) EYE PROTECTION METHOD, DISPLAY DEVICE, EYE PROTECTION APPARATUS, AND STORAGE MEDIUM

(71) Applicant: TCL COMMUNICATION (NINGBO) CO., LTD., Ningbo, Zhejiang (CN)

(72) Inventors: Guangyue LUO, Ningbo, Zhejiang (CN); Jie LUO, Ningbo, Zhejiang (CN); Yunguo ZHAO, Ningbo, Zhejiang (CN)

(73) Assignee: TCL COMMUNICATION (NINGBO) CO., LTD., Ningbo, Zhejiang (CN)

(21) Appl. No.: 19/147,689

(22) PCT Filed: Jul. 26, 2023
(86) PCT No.: PCT/CN2023/109411

§ 371 Date: Jul. 11, 2025

(30) Foreign Application Priority Data
Dec. 7, 2022 (CN) 202211562877.0

(51) Int. Cl. H05B 47/11; G01J 1/42; G06T 7/90; H04M 1/72

(52) U.S. Cl. CPC H05B 47/11; G01J 1/4204; G06T 7/90; H04M 1/72

(57) ABSTRACT

An eye protection method, a display device, an eye protection apparatus, and a storage medium. The eye protection method comprises: if a display screen is in a screen-on state and the brightness of an environment where the display screen is located is lower than a first brightness threshold, acquiring display information of a plurality of display areas of the display screen; determining corresponding driving information according to the display information; determining a corresponding light-emitting device according to the position of each display area on the display screen; and driving, according to the driving information, the corresponding light-emitting device to emit light, so that the emitted light matches each display area. The eye protection method can provide better visual experience for a user.

This application claims the priority of Chinese Patent Application No. 202211562877.0, entitled “EYE PROTECTION METHOD, DISPLAY DEVICE, EYE PROTECTION APPARATUS, AND STORAGE MEDIUM”, filed on Dec. 7, 2022, the disclosure of which is incorporated herein by reference in its entirety.

### FIELD OF THE DISCLOSURE

The present disclosure relates to a field of electronic technology, and in particular, to an eye protection method, a display device, an eye protection apparatus, and a storage medium.

### BACKGROUND

With the continuous development of technology, mobile phones are capable of performing a wide variety of functions, leading to increased daily usage by users. This imposes a significant burden on the human eyes, particularly when using mobile phones at night or in dark environments, where the damage to the eyes is especially pronounced. As a result, major electronics manufacturers have been actively developing eye protection technologies.

### TECHNICAL PROBLEM

In the related art, the eye protection effect provided by existing eye protection technologies is unsatisfactory.

### TECHNICAL SOLUTION

In a first aspect, an embodiment of the present disclosure provides an eye protection method, applied to a display device that includes a display screen and a light emitter arranged at an interval. The method includes:
acquiring display information of a plurality of display regions of the display screen when the display screen is in a screen-on state and an ambient brightness of the display screen is lower than a first brightness threshold;
determining driving information according to the display information of each display region;
determining a corresponding light emitter based on a position of each display region of the display screen;
driving the light emitter to emit light according to the driving information, so that the light emitted by the light emitter matches the corresponding display region.

In a second aspect, another embodiment of the present disclosure provides a display device. The display device includes a housing, a display screen, a plurality of light emitters, and a processor.

The display screen is disposed on the housing.

The plurality of light emitters are arranged at intervals from the display screen, and disposed on the housing.

The processor is connected to the display screen and the plurality of light emitters, and configured to:
acquire display information of a plurality of display regions of the display screen when the display screen is in a screen-on state and an ambient brightness of the display screen is lower than a first brightness threshold;
determine driving information according to the display information of each display region;
determine a corresponding light emitter based on a position of each display region of the display screen;
drive the light emitter to emit light according to the driving information, so that the light emitted by the light emitter matches the corresponding display region.

In a third aspect, another embodiment of the present disclosure provides an eye protection apparatus, applied to a display device comprising a display screen and a light emitter arranged at an interval. The eye protection apparatus includes an acquisition module, a first determination module, a second determination module, and a driving module.

The acquisition module is configured to acquire display information of a plurality of display regions of the display screen when the display screen is in a screen-on state and an ambient brightness of the display screen is lower than a first brightness threshold.

The first determination module is configured to determine driving information according to the display information of each display region.

The second determination module is configured to determine a corresponding light emitter based on a position of each display region of the display screen.

The driving module is configured to drive the light emitter to emit light according to the driving information, so that the light emitted by the light emitter matches the corresponding display region.

In a fourth aspect, another embodiment of the present disclosure provides a storage medium storing computer program executable by a processor of a computer to perform operations comprising:

acquiring display information of a plurality of display regions of the display screen when the display screen is in a screen-on state and an ambient brightness of the display screen is lower than a first brightness threshold;
determining driving information according to the display information of each display region;
determining a corresponding light emitter based on a position of each display region of the display screen;
driving the light emitter to emit light according to the driving information, so that the light emitted by the light emitter matches the corresponding display region.

### ADVANTAGEOUS EFFECTS

In the present embodiment, the display screen is divided into a plurality of display regions. Driving information corresponding to each display region is determined based on display information of the respective display region. A corresponding light emitter is driven to emit light according to the driving information, such that the light emitted by the light emitter matches the corresponding display region. By driving the corresponding light emitter to emit light, the light emitted by the light emitter illuminates the environment where the corresponding display region is located, thereby preventing the display screen from being in a dark environment. This reduces the stimulation of a small-area screen image on the retina and alleviates eye fatigue. Moreover, in this embodiment, the display screen is divided into multiple display regions, and the images displayed in real time in each display region are different. Therefore, the display information of different display regions, such as brightness information or color information, is also different. The light emitted by the light emitter matches the corresponding display region, for example, the brightness of the light emitted by the light emitter matches the brightness of the corresponding display region, and/or the color of the light emitted by the light emitter matches the color of the corresponding display region. As a result, the light emitted by the light emitter not only extends and expands the light from the display region, but also better matches and coordinates with the image of the corresponding display region. This allows the image displayed on the display screen and the light emitted by the light emitter to be better integrated, providing a better visual experience for the user.

### BRIEF DESCRIPTION OF THE DRAWINGS

FIG. 1 illustrates a flowchart of an eye protection method according to an embodiment of the present disclosure.

FIG. 2 illustrates a schematic diagram of a partitioning manner of a display screen according to a first embodiment of the present disclosure.

FIG. 3 illustrates a schematic diagram of a partitioning manner of a display screen according to a second embodiment of the present disclosure.

FIG. 4 illustrates a schematic diagram of a partitioning manner of a display screen according to a third embodiment of the present disclosure.

FIG. 5 illustrates a flowchart of an eye protection method according to another embodiment of the present disclosure.

FIG. 6 illustrates a flowchart of an eye protection method according to another embodiment of the present disclosure.

FIG. 7 illustrates a block diagram of an eye protection apparatus according to an embodiment of the present disclosure.

FIG. 8 illustrates a block diagram of a display device according to an embodiment of the present disclosure.

FIG. 9 illustrates a block diagram of a display device according to another embodiment of the present disclosure.

### DETAILED DESCRIPTION OF THE PRESENT DISCLOSURE

Please refer to the figures. The same reference numerals denote the same components. The principles of the present disclosure are illustrated by way of example as implemented in an appropriate computing environment. The following description is based on specific embodiments illustrated in the present disclosure and should not be construed as limiting other specific embodiments of the present disclosure that are not detailed herein.

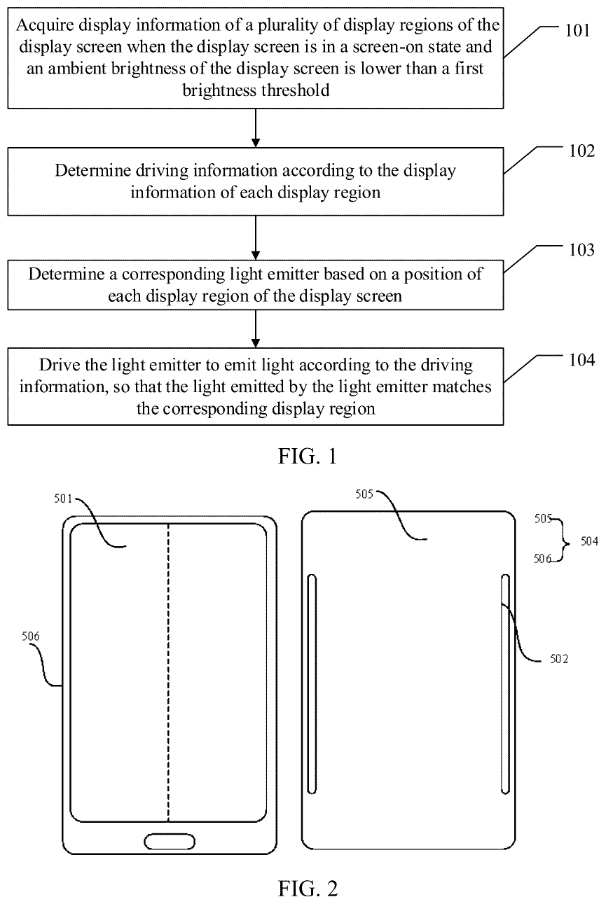

Please refer to FIG. 1 illustrating a flowchart of an eye protection method according to an embodiment of the present disclosure.

The eye protection method may be applied to a display device. The display device may be a device comprising a display screen, such as a tablet, smartphone, television, etc. In the present description, a smartphone is used as an example of the display device. The eye protection method may include steps 101-104.

At step 101, when the display screen is in a screen-on state and the brightness of the environment where the display screen is located is lower than a first brightness threshold, display information of a plurality of display regions of the display screen is acquired.

As an example, the display device may include an ambient light sensor, which can acquire the brightness of the environment of the display device. If the brightness of the environment is lower than the first brightness threshold, it indicates that the display device is in a relatively dark environment. If the brightness is higher than the first brightness threshold, it indicates that the display device is in a relatively bright environment. The first brightness threshold may be set as needed.

In this embodiment, if the display screen is in a screen-on state and the ambient brightness is lower than the first brightness threshold, it indicates that the user is using the display device in a dark environment. At this time, the localized light emitted from the display screen may cause greater stimulation to the human eye, and the damage to the eyes can be particularly severe.

When it is detected that the user is using the display device in a dark environment, the eye protection mode can be automatically activated, and display information of a plurality of display regions of the display screen can be further acquired. The display information may include brightness information, color information, and the like.

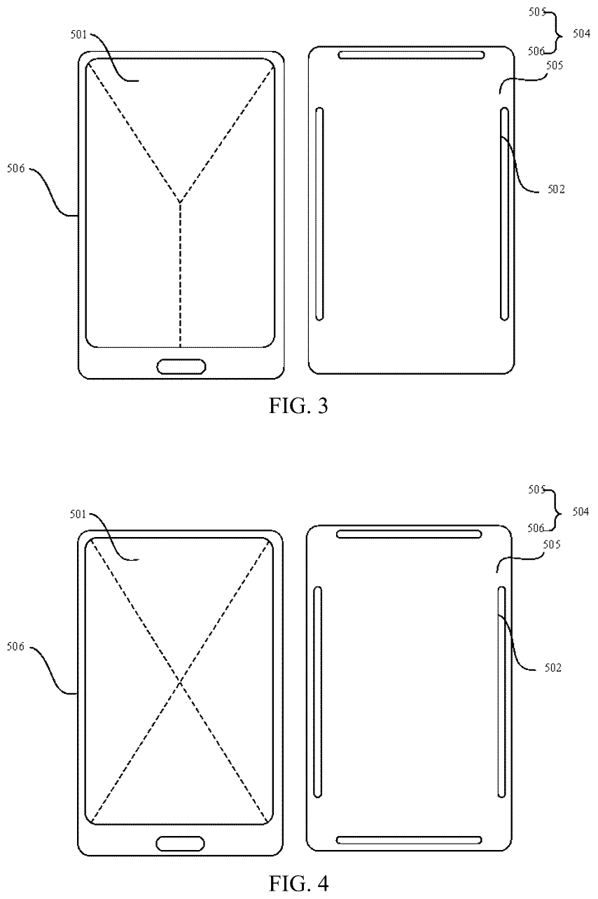

The display screen may be divided into a plurality of display regions, for example, into two display regions, three display regions, four display regions, or more. As an example, please refer to FIG. 2 to FIG. 4. FIG. 2 illustrates a schematic diagram of a partitioning manner of a display screen according to a first embodiment of the present disclosure. FIG. 3 illustrates a schematic diagram of a partitioning manner of a display screen according to a second embodiment of the present disclosure. FIG. 4 illustrates a schematic diagram of a partitioning manner of a display screen according to a third embodiment of the present disclosure.

In the first partitioning manner, the display screen may be divided into left and right regions. In the second partitioning manner, the display screen may be divided into a top region and left and right regions, for example, in a Y-shaped distribution. In the third partitioning manner, the display screen may be divided into top, bottom, left, and right regions, for example, in an X-shaped distribution. It should be noted that this embodiment does not limit the number of display regions, nor does it limit the manner of partitioning the display screen. The sizes of the multiple display regions may be the same or different from each other.

At step 102, driving information corresponding to each display region is determined according to the display information of each display region.

At step 103, a corresponding light emitter is determined according to the position of each display region on the display screen.

At step 104, the corresponding light emitter is driven to emit light according to the driving information, so that the light emitted by the light emitter matches the corresponding display region.

The display device includes a light emitter arranged at an interval from the display screen. Specifically, the display device comprises a rear shell disposed opposite to the display screen, and four side edges surrounding the display screen, namely an upper side edge, a lower side edge, a left side edge, and a right side edge. The rear shell includes four first regions adjacent to the four side edges, namely an upper first region, a lower first region, a left first region, and a right first region. The light emitters may be disposed on the four side edges or on the four first regions of the rear shell.

A corresponding light emitter is determined based on the position of each display region on the display screen. It can be understood that the light emitter closest to a given display region is the corresponding light emitter for that display region. The light emitted by the light emitter can extend the light emitted by the corresponding display region, effectively expanding the outer boundary of the display region.

As an example, in the first partitioning manner, the display screen is divided into a left display region and a right display region. Two light emitters may be provided: a first light emitter disposed on the left side edge or the left first region of the display screen, and a second light emitter disposed on the right side edge or the right first region of the display screen. In this case, the left display region corresponds to the first light emitter, and the right display region corresponds to the second light emitter.

In the second partitioning manner, the display screen may be divided into three display regions, such as a top display region and left and right display regions, for example in a Y-shaped distribution. Three light emitters may be provided: a third light emitter disposed on the upper side edge or upper first region of the display screen, a fourth light emitter disposed on the left side edge or left first region, and a fifth light emitter disposed on the right side edge or right first region. In this case, the top display region corresponds to the third light emitter, the left display region corresponds to the fourth light emitter, and the right display region corresponds to the fifth light emitter.

In the third partitioning manner, the display screen may be divided into four display regions: upper, lower, left, and right, for example, in an X-shaped distribution. Four light emitters may be provided: a sixth light emitter disposed on the upper side edge or upper first region of the display screen, a seventh light emitter disposed on the left side edge or left first region, an eighth light emitter disposed on the right side edge or right first region, and a ninth light emitter disposed on the lower side edge or lower first region. In this case, the upper display region corresponds to the sixth light emitter, the left display region corresponds to the seventh light emitter, the right display region corresponds to the eighth light emitter, and the lower display region corresponds to the ninth light emitter.

This embodiment does not limit the number or position of the light emitters. For example, in the first partitioning manner, a light emitter may additionally be disposed on the upper side edge or upper first region, and/or on the lower side edge or lower first region of the display screen. Similarly, in the second partitioning manner, a light emitter may additionally be disposed on the lower side edge or lower first region of the display screen.

As an example, the light emitters may be arranged according to the display regions. For instance, one light emitter may correspond to one display region. That is, if there are three display regions, three corresponding light emitters may be used, with the positions of the light emitters corresponding to the positions of the display regions. In another example, the light emitters may be arranged independently of the display regions. For instance, light emitters may be disposed on all four side edges or in all four first regions, and light emission may be controlled using light emitters of different numbers and at different positions depending on the number and partitioning manner of the display regions on the display screen.

This embodiment does not limit the manner in which the display screen is partitioned. However, the display regions may be partitioned based on the boundary of the display screen, that is, each display region has a portion of the boundary. Therefore, a light emitter may be disposed near the boundary of each display region, for example, on a side edge or on the rear shell near the boundary, so that the light emitter is located close to the corresponding display region.

In this embodiment, driving information corresponding to each display region is determined based on the display information of the display region. A corresponding light emitter is driven to emit light according to the driving information, such that the light emitted by the light emitter matches the corresponding display region. By driving the corresponding light emitter to emit light, the light emitted by the light emitter illuminates the environment where the corresponding display region is located, thereby preventing the display screen from being in a dark environment. This reduces the stimulation of a small-area screen image on the retina and alleviates eye fatigue.

Furthermore, in this embodiment, the display screen is divided into a plurality of display regions, each of which displays different content in real time. Therefore, the display information corresponding to different display regions, such as brightness information or color information, is also different. The light emitted by the light emitter matches the corresponding display region, for example, the brightness of the light emitted by the light emitter matches the brightness of the corresponding display region, and/or the color of the light emitted by the light emitter matches the color of the corresponding display region. As a result, the light emitted by the light emitter not only extends and expands the light emitted from the display region, but also better matches and coordinates with the content displayed in the corresponding display region. The image displayed on the display screen and the light emitted by the light emitter can be better integrated in terms of brightness, thereby providing a better visual experience for the user.

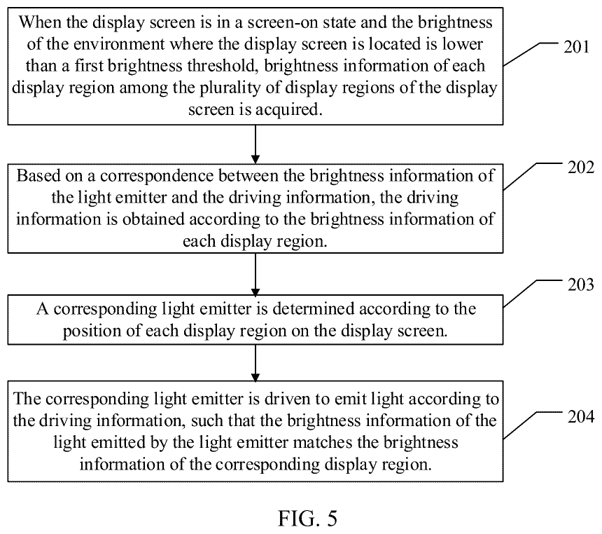

Please refer to FIG. 5 illustrating a flowchart of an eye protection method according to another embodiment of the present disclosure.

The method may include steps 201-204.

At step 201, when the display screen is in a screen-on state and the brightness of the environment where the display screen is located is lower than a first brightness threshold, brightness information of each display region among the plurality of display regions of the display screen is acquired.

At step 202, based on a correspondence between the brightness information of the light emitter and the driving information, the driving information is obtained according to the brightness information of each display region.

At step 203, a corresponding light emitter is determined according to the position of each display region on the display screen.

At step 204, the corresponding light emitter is driven to emit light according to the driving information, such that the brightness information of the light emitted by the light emitter matches the brightness information of the corresponding display region.

As an example, the display device may include an ambient light sensor. The ambient brightness of the environment in which the display device is located may be acquired through the ambient light sensor of the display device. If the ambient brightness is lower than the first brightness threshold, it indicates that the display device is in a relatively dark environment. If the ambient brightness is higher than the first brightness threshold, it indicates that the display device is in a relatively bright environment.

When the display screen is in a screen-on state and the ambient brightness of the display screen is lower than the first brightness threshold, it indicates that the user is using the display device in a dark environment. At this time, the localized light emitted by the display screen may cause greater stimulation to the human eye, and the damage to the eyes may be particularly significant.

In this embodiment, if it is detected that the user is using the display device in a dark environment, an eye protection mode may be automatically activated. Then, display information of a plurality of display regions of the display screen may be further acquired, wherein the display information may include brightness information, color information, and the like.

The display screen may be divided into a plurality of display regions, for example, into two display regions, three display regions, four display regions, or more. As an example, please refer to FIG. 2 to FIG. 4. In the first partitioning manner, the display screen may be divided into left and right regions. In the second partitioning manner, the display screen may be divided into a top region and left and right regions, for example, in a Y-shaped distribution. In the third partitioning manner, the display screen may be divided into upper, lower, left, and right regions, for example, in an X-shaped distribution.

The display device includes a light emitter arranged at an interval from the display screen. The display device comprises a rear shell disposed opposite to the display screen, and four side edges surrounding the display screen. The rear shell includes four first regions adjacent to the four side edges. The light emitters may be disposed on the four side edges—namely the upper, lower, left, and right side edges—or may be disposed in the four first regions of the rear shell—namely the upper, lower, left, and right first regions.

A corresponding light emitter is determined according to the position of each display region on the display screen. It can be understood that the light emitter closest to each display region is the corresponding light emitter for that region. The light emitted by such a light emitter can extend the light emitted by the corresponding display region, effectively expanding the outer boundary of that display region.

As an example, in the first partitioning manner, the display screen is divided into a left display region and a right display region. Two light emitters may be provided: a first light emitter disposed on the left side edge or the left first region of the display screen, and a second light emitter disposed on the right side edge or the right first region of the display screen. In this case, the left display region corresponds to the first light emitter, and the right display region corresponds to the second light emitter.

In the second partitioning manner, the display screen may be divided into a top display region and left and right display regions, for example, in a Y-shaped distribution. Three light emitters may be provided: a third light emitter disposed on the upper side edge or the upper first region of the display screen, a fourth light emitter disposed on the right side edge or the right first region, and a fifth light emitter disposed on the left side edge or the left first region. In this case, the top display region corresponds to the third light emitter, the left display region corresponds to the fourth light emitter, and the right display region corresponds to the fifth light emitter.

In the third partitioning manner, the display screen may be divided into four display regions: upper, lower, left, and right, for example, in an X-shaped distribution. Four light emitters may be provided: a sixth light emitter disposed on the upper side edge or the upper first region of the display screen, a seventh light emitter disposed on the right side edge or the right first region, an eighth light emitter disposed on the left side edge or the left first region, and a ninth light emitter disposed on the lower side edge or the lower first region. In this case, the upper display region corresponds to the sixth light emitter, the left display region corresponds to the seventh light emitter, the right display region corresponds to the eighth light emitter, and the lower display region corresponds to the ninth light emitter.

This embodiment does not limit the manner in which the display screen is partitioned. However, the display regions may be divided based on the boundary of the display screen. That is, each display region includes a portion of the boundary, such that a light emitter may be disposed near the boundary, for example, at a side edge or a location on the rear shell near the boundary, so that the light emitter is positioned close to the corresponding display region.

In this embodiment, if it is detected that the display screen is in a screen-on state and the ambient brightness of the display screen is lower than a first brightness threshold, brightness information of a plurality of display regions of the display screen is acquired. Since each display region displays different content in real time, the brightness information corresponding to different display regions is also different.

To ensure that the brightness information of the light emitted by the light emitter matches the brightness information of the display region, a correspondence between the brightness of the light emitter and the brightness information of the display region may be preset. For example, the correspondence may be a positive correlation: the higher the brightness of the display region, the higher the brightness of the corresponding light emitter; the lower the brightness of the display region, the lower the brightness of the corresponding light emitter. The light emitted by the light emitter can illuminate the environment where the corresponding display region is located, preventing the display screen from being in a dark environment. This reduces the stimulation of a small-area screen image on the retina and alleviates eye fatigue.

Moreover, the brightness of the light emitted by the light emitter varies with the brightness of the corresponding display region, such that the brightness of the ambient light matches the brightness of the corresponding display region. As a result, the image displayed on the display screen can be more harmoniously integrated with the ambient light, thereby providing a better visual experience for the user.

As an example, the brightness of the light emitted by the light emitter may be dynamically adjusted to 80%, 90%, or another proportion of the brightness of the corresponding display region. It is understood that the brightness of the light emitted by the light emitter is slightly lower than the brightness of the corresponding display region, so that the light emitted by the light emitter not only harmoniously extends and expands the light emitted by the corresponding display region, but also appears relatively soft, thereby making the user's viewing experience more comfortable.

In this embodiment, the brightness information of each display region can be acquired in real time. As an example, the brightness information of each display region may be the average brightness of all pixel points in that region. In another example, each pixel point in a display region may have a different brightness weight. The brightness information of the display region may be determined based on the brightness of each pixel point and the corresponding brightness weight, thereby making the acquired brightness information of each display region more accurately reflect the actual screen brightness.

This embodiment does not limit the method of acquiring brightness information of the display regions. For example, gradient-weight methods, regional sampling methods, or other techniques may also be used to acquire the brightness information of the display regions.

Then, corresponding brightness information of the light emitter is obtained based on the brightness information of the display region. Subsequently, driving information of the corresponding light emitter is obtained based on a correspondence between the brightness information of the light emitter and the driving information. The corresponding light emitter is then driven to emit light according to the driving information, such that the brightness of the light emitted by the light emitter can be precisely controlled.

For example, in the third partitioning manner, the display screen is divided into four display regions, wherein the upper display region corresponds to a sixth light emitter, the left display region corresponds to a seventh light emitter, the right display region corresponds to an eighth light emitter, and the lower display region corresponds to a ninth light emitter. In this case, the brightness of the sixth light emitter matches the brightness of the upper display region, the brightness of the seventh light emitter matches the brightness of the left display region, the brightness of the eighth light emitter matches the brightness of the right display region, and the brightness of the ninth light emitter matches the brightness of the lower display region. As a result, the light emitted by each light emitter not only extends and expands the light emitted by the corresponding display region, but also more closely matches and coordinates with the brightness of the image displayed in the corresponding display region. The light emitted by the light emitter illuminates the environment where the corresponding display region is located, so that the image displayed on the display screen can be better integrated with the ambient light in terms of brightness, thereby providing a better visual experience for the user.

In one embodiment, if the brightness information of a display region is lower than a second brightness threshold, the light emitter corresponding to that display region is controlled to emit light at a first brightness value. In this embodiment, even if the brightness information of the display region is very low, the light emitter is still controlled to emit light at a relatively low first brightness value, so that the display screen is never in an overly dark environment. This effectively relieves eye strain for the user and achieves a better eye protection effect.

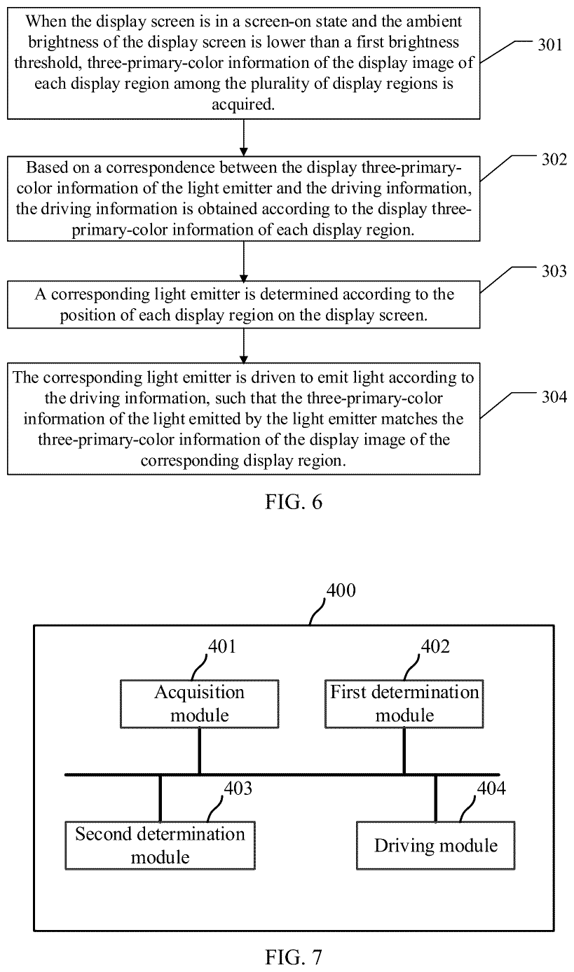

Please refer to FIG. 6 illustrating a flowchart of an eye protection method according to another embodiment of the present disclosure. The method includes steps 301-304.

At step 301, when the display screen is in a screen-on state and the ambient brightness of the display screen is lower than a first brightness threshold, three-primary-color information of the display image of each display region among the plurality of display regions is acquired.

At step 302, based on a correspondence between the display three-primary-color information of the light emitter and the driving information, the driving information is obtained according to the display three-primary-color information of each display region.

At step 303, a corresponding light emitter is determined according to the position of each display region on the display screen.

At step 304, the corresponding light emitter is driven to emit light according to the driving information, such that the three-primary-color information of the light emitted by the light emitter matches the three-primary-color information of the display image of the corresponding display region.

The difference between this embodiment and the previous embodiment lies in that the acquired display information of the display region is the three-primary-color information of the display image of the display region. The three-primary-color information refers to RGB values, which are numerical combinations used to represent the color of an image based on the three primary colors: red (R), green (G), and blue (B). Each value ranges as follows: R [0, 255], G [0, 255], and B [0, 255]. By acquiring the RGB values of the display image of the display region, color information of the display region can be obtained. The color information may include hue, saturation, and brightness.

As an example, the color information of each display region may be the average RGB value of all pixel points in the display region. In another example, each pixel point in the display region may have a different color weight. The color information of the display region may be determined based on the RGB value and the corresponding color weight of each pixel point, such that the obtained color information more closely reflects the actual color of the image. This embodiment does not limit the method of acquiring color information of the display region. For example, gradient weighting methods, regional sampling methods, and other techniques may also be used to acquire the color information of the display region.

This embodiment allows real-time acquisition of the three-primary-color information of the display image of each display region among the plurality of display regions of the display screen. Based on a correspondence between the display three-primary-color information of the light emitter and the driving information, the driving information is obtained according to the three-primary-color information of each display region. The corresponding light emitter is driven to emit light according to the driving information, such that the three-primary-color information of the light emitted by the light emitter matches the three-primary-color information of the display image of the corresponding display region.

After acquiring the three-primary-color information of the display region, i.e., the color information, in order to ensure that the three-primary-color information of the light emitted by the light emitter, i.e., the emission color of the light emitter, matches the color information of the display image of the corresponding display region, the emission color of the light emitter may be configured to display according to the color information of the display region. The emission color of the light emitter may change in real time along with the color changes of the corresponding display region. The emission color of the light emitter may be consistent with or similar to the color of the corresponding display region.

For example, in the third partitioning manner, the display screen is divided into four display regions, wherein the upper display region corresponds to a sixth light emitter, the left display region corresponds to a seventh light emitter, the right display region corresponds to an eighth light emitter, and the lower display region corresponds to a ninth light emitter. In this case, the emission color of the sixth light emitter matches the color of the upper display region, the emission color of the seventh light emitter matches the color of the left display region, the emission color of the eighth light emitter matches the color of the right display region, and the emission color of the ninth light emitter matches the color of the lower display region. As a result, the light emitted by the light emitters not only extends and expands the light emitted by the corresponding display regions, but also more closely matches and coordinates with the color of the image in the corresponding display regions. The light emitted by the light emitter illuminates the environment where the corresponding display region is located, enabling the display image of the display screen and the ambient light to be more harmoniously integrated in terms of color, thereby providing a better visual experience for the user.

In another embodiment, when the display screen is in a screen-on state and the ambient brightness of the display screen is lower than a first brightness threshold, brightness information of each display region and three-primary-color information of the display image of each display region may be acquired simultaneously. Corresponding driving information is determined based on the brightness information and the three-primary-color information of each display region. A corresponding light emitter is then driven to emit light according to the driving information, such that both the brightness information and color information of the light emitted by the light emitter match those of the corresponding display region. This allows the image displayed on the display screen to be more harmoniously integrated with the ambient light in both brightness and color, thereby improving the visual experience of the user while achieving the effect of eye protection.

It should be noted that portions of this embodiment that are not described in detail may refer to the detailed descriptions provided in the previous embodiments, which are not repeated here.

In one embodiment, the light emitter corresponding to each display region comprises a plurality of light-emitting units. Driving the corresponding light emitter to emit light according to the driving information includes: acquiring a first region of the light emitter that is occluded and a second region that is not occluded; controlling the light-emitting units corresponding to the first region to not emit light, and controlling the light-emitting units corresponding to the second region to emit light.

It is understood that when the user is using the display device, such as when holding a smartphone, part of the light emitter may be occluded by the user's hand. For example, the light emitter may include a first region that is occluded and a second region that is not occluded. It is further understood that even if the light-emitting units in the first occluded region emit light, the light may be blocked and may not effectively illuminate the location of the corresponding display region. Therefore, by controlling the light-emitting units in the occluded first region to not emit light, power consumption of the light emitter can be saved.

It should be noted that when the display screen is in a screen-on state and the ambient brightness of the display screen is lower than a first brightness threshold, any of the eye protection methods of the present disclosure may be automatically activated. The user may also manually enable or disable any of the eye protection methods of the present disclosure at any time.

Furthermore, the eye protection method of the present embodiment may include, in addition to any of the eye protection methods described above, the activation of other eye protection techniques such as low blue light, flicker-free, circular polarization, and the like, so that the display device can achieve a better eye protection effect and provide an improved user experience.

Please refer to FIG. 7 illustrating a block diagram of an eye protection apparatus 400 according to an embodiment of the present disclosure. The eye protection apparatus 400 is applied to a display device. The display device includes a display screen and a light emitter arranged with spacing. The eye protection apparatus 400 includes an acquisition module 401, a first determination module 402, a second determination module 403, and a driving module 404.

The acquisition module 401 is configured to: when the display screen is in a screen-on state and the ambient brightness of the display screen is lower than a first brightness threshold, acquire display information of a plurality of display regions of the display screen.

The first determination module 402 is configured to: determine corresponding driving information based on the display information of each display region.

The second determination module 403 is configured to: determine the corresponding light emitter based on the position of each display region on the display screen.

The driving module 404 is configured to: drive the corresponding light emitter to emit light based on the driving information, such that the light emitted by the light emitter corresponding to each display region matches the respective display region.

In one embodiment, the acquisition module 401 may be configured to acquire brightness information of each display region among the plurality of display regions of the display screen. The first determination module 402 may be configured to obtain driving information based on a correspondence between brightness information of the light emitter and the driving information, according to the brightness information of each display region. The driving module 404 may be configured to drive the corresponding light emitter to emit light based on the driving information, such that the brightness information of the light emitted by the light emitter matches the brightness information of the corresponding display region.

In one embodiment, the driving module 404 may be configured to, if the brightness information of a display region is lower than a second brightness threshold, control the light emitter corresponding to the display region to emit light with a first brightness value.

In one embodiment, the acquisition module 401 may be configured to acquire primary color information of the display picture of each display region among the plurality of display regions of the display screen. The first determination module 402 may be configured to obtain driving information based on a correspondence between the primary color information of the light emitter and the driving information, according to the primary color information of each display region. The driving module 404 may be configured to drive the corresponding light emitter to emit light based on the driving information, such that the primary color information of the light emitted by the light emitter matches the primary color information of the display picture of the corresponding display region.

In one embodiment, the light emitter corresponding to each display region comprises a plurality of light-emitting units. The driving module 404 may be configured to: acquire a first region of each light emitter that is obstructed and a second region that is unobstructed; control the light-emitting units corresponding to the first region not to emit light, and control the light-emitting units corresponding to the second region to emit light.

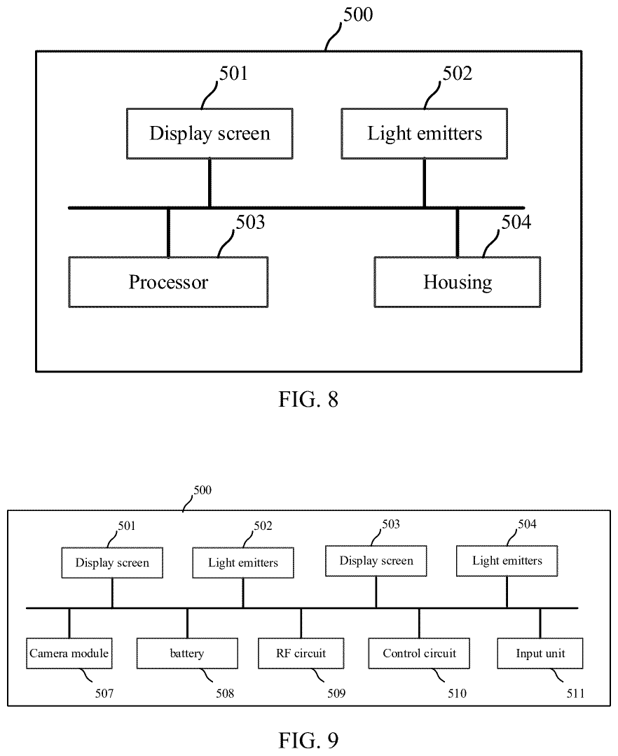

Please refer to FIG. 8. FIG. 8 illustrates a block diagram of a display device according to an embodiment of the present disclosure. The display device 500 includes a display screen 501, a plurality of light emitters 502, a processor 503, and a housing 504.

The display screen 501 may include a plurality of display regions, such as two, three, four, or more display regions. Exemplarily, the display regions may be divided based on the boundary of the display screen, that is, each display region has a portion of the boundary, such that a light emitter 502 can be disposed near the boundary to be adjacent to the corresponding display region. The display screen 501 may be used to display information input by a user, information provided to the user, as well as various graphical user interfaces of the terminal, wherein the graphical user interfaces may include images, text, icons, videos, or any combination thereof.

A plurality of light emitters 502 are arranged spaced apart from the display screen 501. Exemplarily, the display device 500 further comprises a housing 504, which serves as the main carrier of the display device 500. The display screen 501 and the light emitters 502 are both disposed on the housing 504. The housing 504 comprises a rear cover 505 disposed opposite to the display screen 501, and four side edges 506 surrounding the display screen 501. The rear cover 505 includes four first regions (not labeled in the figure) adjacent to the four side edges 506, and at least two of the first regions are provided with light emitters 502. In another example, the display device 500 includes a plurality of side edges 506 surrounding the display screen, and at least two side edges 506 are provided with light emitters 502. In yet another example, the light emitter 502 is disposed in the first region and tilted toward the direction of the side edge 506, such that the light-emitting surface of the light emitter 502 emits light in a direction both away from the display screen 501 and toward the side edge 506 of the display screen 501, thereby providing improved lighting compensation for the display screen 501 and achieving a better eye protection effect.

Exemplarily, each light emitter 502 is internally provided with at least one group of light-emitting units, wherein each group of light-emitting units includes at least red, green, and blue primary color light-emitting units, such that the light emitter is capable of emitting colored light. This allows the emitted light color of the light emitter to match the color of the image displayed in the corresponding display region, thereby enhancing the visual experience of the user while achieving an eye protection effect.

The processor 503 serves as the control center of the display device 500. It is connected to various parts of the display device through different interfaces and circuits, and is configured to operate or execute applications, invoke data, and perform various functions and data processing of the display device 500, thereby achieving overall control of the display device 500.

In this embodiment, the processor 503 of the display device 500 is configured to execute the following instructions:
if the display screen is in a screen-on state and the ambient brightness of the display screen is lower than a first brightness threshold, acquiring display information of a plurality of display regions of the display screen;
determining, based on the display information of each display region, corresponding driving information;
determining, based on the position of each display region on the display screen, a corresponding light emitter; and
driving the corresponding light emitter to emit light according to the driving information, so that the light emitted by the light emitter matches the corresponding display region.

In one embodiment, in the process of acquiring display information of a plurality of display regions of the display screen, the processor 503 is configured to:
acquire brightness information of each of the plurality of display regions of the display screen;
wherein determining the corresponding driving information based on the display information of each display region comprises:
obtaining the driving information based on the brightness information of each display region and a correspondence between brightness information and driving information of the light emitter;
and driving the corresponding light emitter to emit light based on the driving information, such that the light emitted by the light emitter matches the corresponding display region comprises:
driving the corresponding light emitter to emit light such that the brightness information of the emitted light matches the brightness information of the corresponding display region.

In one embodiment, during the process of acquiring display information of multiple display regions of the display screen, the processor 503 is configured to acquire brightness information of each of the multiple display regions of the display screen;
during the process of determining, based on the display information of each display region, corresponding driving information, the processor 503 is further configured to:
obtain the driving information based on the brightness information of each display region and a correspondence between brightness information and driving information of the light emitter; and
during the process of driving the corresponding light emitter to emit light according to the driving information such that the light emitted by the light emitter matches the corresponding display region, the processor 503 is further configured to drive the corresponding light emitter to emit light such that the brightness information of the emitted light matches the brightness information of the corresponding display region.

In one embodiment, after acquiring brightness information of each of the multiple display regions of the display screen, the processor 503 is configured to control the light emitter corresponding to a display region to emit light at a first brightness value if the brightness information of the display region is less than a second brightness threshold.

In another embodiment, the light emitter comprises primary color light-emitting units. During the process of acquiring display information of the multiple display regions of the display screen, the processor 503 is further configured to acquire primary color information of the display image of each display region among the multiple display regions of the display screen;
during the process of determining, based on the display information of each display region, corresponding driving information, the processor 503 is configured to obtain the driving information based on a correspondence between the display primary color information and driving information of the light emitter and the primary color information of each display region;
and during the process of driving the corresponding light emitter to emit light according to the driving information such that the light emitted by the light emitter matches the corresponding display region, the processor 503 is configured to drive the corresponding light emitter to emit light such that the primary color information of the emitted light matches the primary color information of the display image of the corresponding display region.

In one embodiment, each light emitter corresponding to a display region comprises multiple light-emitting units. During the process of driving the corresponding light emitter to emit light based on the driving information, the processor 503 is configured to:
acquire a first region of each light emitter that is obstructed and a second region of each light emitter that is unobstructed;
control the light-emitting units corresponding to the first region to not emit light, and control the light-emitting units corresponding to the second region to emit light.

Please refer to FIG. 9 illustrating a block diagram of a display device according to another embodiment of the present disclosure. The display device 500 may further include components such as a camera module 507, a battery 508, a radio frequency (RF) circuit 509, a control circuit 510, and an input unit 511.

The camera module 507 may be configured for video recording and image acquisition. It captures images through a lens, processes the images via a photosensitive circuit and control circuit within the camera, and reconstructs the images using software, such that the images can be displayed on the display screen.

The battery 508 may be configured to supply power to various modules and components of the electronic device.

The radio frequency (RF) circuit 509 is configured to transmit and receive RF signals to communicate wirelessly with network devices or other electronic devices.

The control circuit 510 is electrically connected to the display screen 501 and is configured to control the display of information on the display screen 501.

The input unit 511 may be configured to receive input of numeric or character information or user characteristic information (e.g., fingerprint), and to generate signals related to user settings and functional control, such as input signals from a keyboard, mouse, joystick, optical sensor, or trackball.

It should be noted that the display device may further include components such as a microphone, a speaker, and an accelerometer.

It should be understood that, for the eye protection method of the present disclosure, those skilled in the art will appreciate that all or part of the process may be implemented by a computer program to control associated hardware. The computer program may be stored on a computer-readable storage medium, such as in a memory, and executed by at least one processor. During execution, the process may include steps of the eye protection method as disclosed in the embodiments. The storage medium may include, for example, a magnetic disk, optical disk, read-only memory (ROM), or random-access memory (RAM).

In the above embodiments, each embodiment focuses on different aspects, and parts not described in detail in a particular embodiment may be referenced from the detailed description of the eye protection method provided earlier. These portions will not be repeated here.

The foregoing provides a detailed description of the eye protection method, eye protection apparatus, storage medium, and display device as offered by the present disclosure. Specific examples are used herein to illustrate the principles and implementations of the present disclosure. These descriptions are merely intended to aid understanding of the method and core concepts. For those skilled in the art, modifications may be made in the specific implementation and scope of application based on the teachings of the present disclosure. Therefore, the content of this specification should not be construed as limiting the present disclosure.

1. An eye protection method, applied to a display device, comprising a display screen and a light emitter arranged at an interval, the method comprising:
acquiring display information of a plurality of display regions of the display screen when the display screen is in a screen-on state and an ambient brightness of the display screen is lower than a first brightness threshold;
determining driving information according to the display information of each display region;
determining a corresponding light emitter based on a position of each display region of the display screen; and
driving the light emitter to emit light according to the driving information, so that the light emitted by the light emitter matches the corresponding display region.

2. The eye protection method according to claim 1, wherein the acquiring the display information of the plurality of display regions of the display screen comprises:
acquiring brightness information of each display region among the plurality of display regions of the display screen;
the determining driving information according to the display information of each display region comprises:
obtaining the driving information according to a correspondence between the brightness information of the light emitter and the driving information;
the driving the corresponding light emitter to emit light according to the driving information, so that the light emitted by the light emitter matches the corresponding display region comprises:
driving the light emitter to emit light according to the driving information, such that the brightness information of the light emitted by the light emitter matches the brightness information of the corresponding display region.

3. The eye protection method according to claim 2, further comprising:
controlling the light emitter corresponding to the display region to emit light at a first brightness value when the brightness information of the display region is lower than a second brightness threshold.

4. The eye protection method according to claim 1, wherein the light emitter comprises a primary color light-emitting unit, and the acquiring the display information of the plurality of display regions of the display screen comprises:
acquiring primary color information of the display image of each display region among the plurality of display regions;
the determining the driving information according to the display information of each display region comprises:
obtaining the driving information according to a correspondence between the primary color information of the light emitter and the driving information and according to the primary color information of each display region;
the driving the corresponding light emitter to emit light according to the driving information, so that the light emitted by the light emitter matches the corresponding display region comprises:
driving the light emitter to emit light according to the driving information, such that the primary color information of the light emitted by the light emitter matches the primary color information of the display image of the corresponding display region.

5. The eye protection method according to claim 1, wherein the light emitter corresponding to each display region comprises a plurality of light-emitting units;
the driving the corresponding light emitter to emit light according to the driving information comprises:
acquiring a first region of the light emitter that is occluded and a second region that is not occluded; and
controlling a light-emitting unit corresponding to the first region not emit light, and controlling a light-emitting unit corresponding to the second region to emit light.

6. A display device, comprising:
a housing;
a display screen, disposed on the housing;
a plurality of light emitters, arranged at intervals from the display screen, and disposed on the housing;
a processor, connected to the display screen and the plurality of light emitters, and configured to:
acquire display information of a plurality of display regions of the display screen when the display screen is in a screen-on state and an ambient brightness of the display screen is lower than a first brightness threshold;
determine driving information according to the display information of each display region;
determine a corresponding light emitter based on a position of each display region of the display screen; and
drive the light emitter to emit light according to the driving information, so that the light emitted by the light emitter matches the corresponding display region.

7. The display device according to claim 6, wherein when acquiring the display information of the plurality of display regions of the display screen, the processor is configured to acquire brightness information of each display region among the plurality of display regions of the display screen;
when determining driving information according to the display information of each display region, the processor is configured to obtain the driving information according to a correspondence between the brightness information of the light emitter and the driving information;
when driving the corresponding light emitter to emit light according to the driving information, so that the light emitted by the light emitter matches the corresponding display region, the processor is configured to drive the light emitter to emit light according to the driving information, such that the brightness information of the light emitted by the light emitter matches the brightness information of the corresponding display region.

8. The display device according to claim 7, wherein after acquiring brightness information of each display region, the processor is further configured to control the light emitter corresponding to the display region to emit light at a first brightness value when the brightness information of the display region is lower than a second brightness threshold.

9. The display device according to claim 6, wherein the light emitter comprises a primary color light-emitting unit; when acquiring the display information of the plurality of display regions of the display screen, the processor is configured to:
acquire primary color information of the display image of each display region among the plurality of display regions;
when determining the driving information according to the display information of each display region, the processor is configured to obtain the driving information according to a correspondence between the primary color information of the light emitter and the driving information and according to the primary color information of each display region;
when driving the corresponding light emitter to emit light according to the driving information, so that the light emitted by the light emitter matches the corresponding display region, the processor is configured to drive the light emitter to emit light according to the driving information, such that the primary color information of the light emitted by the light emitter matches the primary color information of the display image of the corresponding display region.

10. The display device according to claim 6, wherein the light emitter corresponding to each display region comprises a plurality of light-emitting units; the processor is further configured to acquire a first region of the light emitter that is occluded and a second region that is not occluded;
control the light-emitting units corresponding to the first region to not emit light; and control the light-emitting units corresponding to the second region to emit light.

11. The display device according to claim 6, further comprising: a rear shell, disposed opposite to the display screen; and four side edges surrounding the display screen, wherein the rear shell comprises four first regions adjacent to the four side edges, and at least two of the first regions are provided with the light emitters.

12. The display device according to claim 11, wherein the light emitters are disposed in the first regions and inclined toward direction of the side edges.

13. The display device according to claim 6, further comprising a plurality of side edges surrounding the display screen, wherein at least two of the side edges are provided with the light emitters.

14. The display device according to claim 6, wherein each light emitter comprises at least one group of light-emitting units, each group comprising at least three primary color light-emitting units.

15-19. (canceled)

20. A non-transitory storage medium storing computer program executable by a processor of a computer to perform operations comprising:
acquiring display information of a plurality of display regions of the display screen when the display screen is in a screen-on state and an ambient brightness of the display screen is lower than a first brightness threshold;
determining driving information according to the display information of each display region;
determining a corresponding light emitter based on a position of each display region of the display screen; and
driving the light emitter to emit light according to the driving information, so that the light emitted by the light emitter matches the corresponding display region.

21. The non-transitory storage medium according to claim 20, wherein the acquiring the display information of the plurality of display regions of the display screen comprises:
acquiring brightness information of each display region among the plurality of display regions of the display screen;
the determining driving information according to the display information of each display region comprises:
obtaining the driving information according to a correspondence between the brightness information of the light emitter and the driving information;
the driving the corresponding light emitter to emit light according to the driving information, so that the light emitted by the light emitter matches the corresponding display region comprises:
driving the light emitter to emit light according to the driving information, such that the brightness information of the light emitted by the light emitter matches the brightness information of the corresponding display region.

22. The non-transitory storage medium according to claim 21, wherein the operations further comprise:
controlling the light emitter corresponding to the display region to emit light at a first brightness value when the brightness information of the display region is lower than a second brightness threshold.

23. The non-transitory storage medium according to claim 20, wherein the light emitter comprises a primary color light-emitting unit, and the acquiring the display information of the plurality of display regions of the display screen comprises:
acquiring primary color information of the display image of each display region among the plurality of display regions;
the determining the driving information according to the display information of each display region comprises:
obtaining the driving information according to a correspondence between the primary color information of the light emitter and the driving information and according to the primary color information of each display region;
the driving the corresponding light emitter to emit light according to the driving information, so that the light emitted by the light emitter matches the corresponding display region comprises:
driving the light emitter to emit light according to the driving information, such that the primary color information of the light emitted by the light emitter matches the primary color information of the display image of the corresponding display region.

24. The non-transitory storage medium according to claim 20, wherein the light emitter corresponding to each display region comprises a plurality of light-emitting units;
the driving the corresponding light emitter to emit light according to the driving information comprises:
acquiring a first region of the light emitter that is occluded and a second region that is not occluded; and
controlling a light-emitting unit corresponding to the first region not emit light, and controlling a light-emitting unit corresponding to the second region to emit light.
